(19) United States
(12) Patent Application Publication
(10) Pub. No.: US 2001/0011359 A1
(43) Pub. Date: Aug. 2, 2001

(54) Reconfiguration procedure for an error-tolerant computer-supported system with at least one set of observers

(75) Inventors: Thomas Kohler, Munchen (DE); Winfried Lohmiller, Munchen (DE)

Correspondence Address: Ladas & Parry, 26 West 61st Street, New York, NY, 10023, US

(73) Assignee: EADS DEUTSCHLAND GMBH

(21) Appl. No.: 09/768,419

(22) Filed: Jan. 24, 2001

(30) Foreign Application Priority Data
Jan. 28, 2000 (DE) 100 03 583.3

(51) Int. Cl. G06F 11/00

(52) U.S. Cl. 714/48

(57) ABSTRACT

Reconfiguration procedure for an error-tolerant system with at least one set of observers that are each formed from various combinations of sensors and a system model whereby the set of observers cause time-dependent operating statuses to fulfill system functions, whereby past deviations of the measured system status of this combination of one of the estimated system statuses of the assigned observers are used to determine the error status of each of these combinations of sensors for each time interval.

The invention concerns a reconfiguration procedure for an error-tolerant, computer-supported system with at least one set of observers that particularly allows for the recognition and resolution of various sensor errors.

Observers are known from the state of the art, and represent a combination of sensors for partial or complete measurement of the momentary system status and of a system model that describes the temporal behavior of a pre-defined system status. This allows recognition and resolution of various system errors. Using the sensors and a system status model, an observer thus employed evaluates the system status that represents a complete description of the system at any moment. Such an observer might be a Luenberger observer, a Kalman filter, a neural net, or other common observer procedure.

Since the system status is at least partially measured using a sensor, the current error status of the system can be determined and the system can be reconfigured accordingly based on the deviation of that measurement from the measurement expected from the system model. If one or more sensor signals and a system model are available in a system, an observer is usually used to combine these sensor signals with the system model. The observer thereby takes into account the assumed accuracy of the sensor signals and of the system model in a manner that combines these as optimally as possible. The special case of a Kalman filter here guarantees an optimal fusion of all signals. This occurs because of the fact that relatively inaccurate sensor signals or system statuses of the system model are given less weight during system operation than are the more accurate sensor signals or system statuses of the system model, whereby specified sensor or system model accuracy is assumed. This above-named fusion may only be optimal, however, if the assumed accuracy of the sensor signal or system model agrees with the actual accuracy of the sensor signal or system model. In the case of a sensor signal or system model error, i.e., if the specified accuracy of one or more sensors or of the system model cannot be maintained, the observer uses the sensor signals or system status of the system model with the original weighting. For this, the sensor or system model judged to be the more accurate based on the data in combination with other sensor signals or system statuses is then relatively strongly weighted if it delivers inaccurate signals. The observer no longer weights the various signals optimally, so that an overall sub-optimal solution results from the observer. This can lead to a considerable loss in accuracy of observer output signals. This described disadvantage applies to any observer process in accordance with the technical state of the art, especially to those that use a Kalman filter.

In order to recognize sensor or system model errors and to remove them from the system, a so-called observer or Kalman filter bank based on the observer technique was developed in which several observers are used in a temporal sequence. Such a system was published in the pamphlet Bryson, A., Yu-Chi, H, Applied Optimal Control, 1975, on pages 388 and 389. Here, an observer, called the main observer, processes all sensor signals with a system model that is based on a system without system errors. The other observers, so-called sub-observers, in contrast process a subset of the sensor signals to be processed in combination with system models that are based on various system errors. Which sub-observers are to be used in the observer bank depends on which combination of sensor and system errors occur.

Each observer in the observer bank reports a so-called residuum for each sensor measurement that represents the difference between the measured sensor signal and the sensor signal anticipated for this time interval from the observer via the system model. Comparison of this residuum with an anticipated residuum value or accuracy allows determination of the probability density that the last measurement agrees with the system model of the observer. If this probability density falls below a certain threshold value, the case is considered to be an error. In order to recognize errors that build up over time, the known observer bank considers all residua that have arisen in the past when evaluating the residuum probability density. The probability density of all past measurements is determined using a mathematical procedure. In the case of an error, i.e., when the probability density of all past measurements falls below a threshold value in connection with the system model, the observer bank switches to the sub-observer with the highest current probability density.

A disadvantage of this procedure is that all sensor signals occurring before errors which the main observer considered to be incorrect are discarded by the observer bank. These sensor signals which may have been sufficiently accurate before the error occurred, are a result of switching to a corresponding sub-observer. Thereby, all learning effects such as evaluation of sensor offsets or an increased degree of observer accuracy that came into being from the sensor signal before it was switched off are lost. In the case of a system error, the system is switched to a sub-observer that currently contains correct system modeling, but that may not have described the system correctly in the past, since the system error had not yet occurred there. This also leads to a reduction in observer accuracy.

The known state of the art observer bank is also lacking when looking at the accuracy achieved after the error. If the error from the sensor or system model identified as erroneous before recognition of the error was so great that it influences future probability densities (i.e., ones calculated after the error occurred), then the observer bank will not switch back to the main observer. Thus, as a result of a sensor error, the information from future, possibly correct sensor signals from the sensor considered to be erroneous is discarded. For a system error, the system no longer switches to the proper error-free system model, which also leads to a reduction in output signal accuracy.

Both effects together, i.e., the effect relevant for the past and the effect relevant to the future, can lead to a considerable observer bank information loss, since a large portion of correct signals is discarded or not processed with system models considered to be correct.

It is therefore the task of this invention to achieve a procedure to reconfigure an error-tolerant, computer-supported system with at least one set of observers so that the configured system provides the highest degree of accuracy possible.

This task is solved by the features of claim 1. Additional implementation information is available from the subordinate claims.

A system error here might be, for example, a blocked final control element or other erroneous mechanical, electrical, or electronic component.

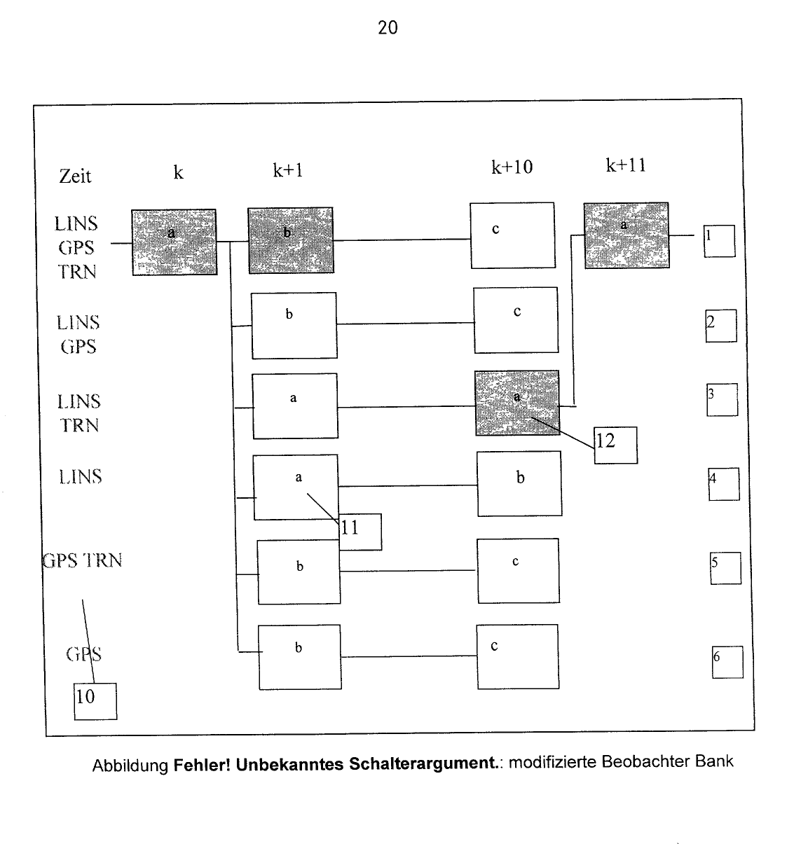

The following will describe the invention using FIG. 1. This illustration shows a schematic representation of sensors for an aircraft navigation system and as an example based on the invention a switching mechanism taking a sensor error. The mechanism may be adapted for various system models in that the various sensor combinations 10 in FIG. 1 may be replaced by various system models. Also, the combination of sensor combinations and various system models is possible.

The example of a sensor-related part of a navigational system shown in FIG. 1 shows the system status and corresponding error status 11 of a main observer and several sub-observers, each in a series of sequential time steps. In the example shown, observers are used to combine the sensors with the system model. “System status” here is defined to mean the complete current description of each system, i.e., the values of all significant values detected by the observer for the current time interval. In order to represent the temporal progression on the one hand and the simultaneity of these characteristics on the other, they are arranged in rows 1, 2, 3, 4, 5, and 6, and columns k to k+11. Columns k to k+11 symbolize the time intervals represented, while rows 1, 2, 3, 4, 5, and 6 contain filters activated during each time interval. For this, row 1 contains the main observer, and rows 2, 3, 4, 5, and 6 contain each sub-observer active for the time interval. Several observers active during the same time interval are designated as an observer bank.

The main observer and the sub-observer use the signals from various sensors 10 as current signals. For this, the main observer preferably uses signals from a maximum number of sensors, while the sub-observers use the signals of a sub-combination of this maximum number of sensors. In FIG. 1, the signals available to the main observer or the sub-observers are designated with abbreviated names of each provided sensor from which the signals derive. Thus, the main observer (column 1) receives the signals of a LINS (Laser Inertial Navigation System), a GPS (Global Positioning System), and a TRN (Terrain Reference Navigation).

Theses sensors are provided for a navigation system in the configuration shown in FIG. 1. For other navigation systems or for sensor systems that are intended for other applications, other sensors and thereby main observers and sub-observers come into play. The mechanism can also be adapted to various system models in that the various sensor combinations 10 may be replaced by different system models. Additionally different sensor combinations and different system models are possible.

FIG. 1 in this example shows the temporal progression using twelve steps during which an error was detected by the sensor signals. The representation shows how the sensor system behaves for the time in which the error occurs, and how it is reconfigured for it. For this, the given time steps k to k+11 show only a section of the overall temporal function progression. The FIGURE shows the first time step with index k, and the second time step with index k+1. Further time steps are not shown in the FIGURE, but continue through to the eleventh step (designated k+10). At the end, the time step k+11 is shown in which the system has achieved exit status in this example.

The blocks 11 symbolizing the system status and error status of the observers or filters describe each error status using a probability value that made a prediction regarding with what probability a predetermined number n of the last measurements by the block were created by the block system model. The probability value can be created from this statistical significance. The significance α of the last n measurements may be determined using the X² (α, n) function and the past n residua. For example, this function may be taken from the book Bronstein, Taschenbuch der Mathematik, 25th edition 1991, p. 680, for example. According to the invention, an error is only sought in the last n measurements rather than over the entire past, as seen according to the state of the art. Thus, according to the invention procedure, a sensor or system-error occurring before the last n measurements no longer influences the current error status. In contrast to conventional procedures in which the error status of all past time intervals is reflected, sensor signals or the system model that are again error-free, might still be evaluated as containing errors, so that the entire system is degraded.

For error status reporting, the probability density of the last n measurements may be used instead of the statistical significance. Determination of probability density may be found in the pamphlet Bryson, A., Yu-Chi, H, Applied Optimal Control, 1975, on pages 388 and 389, and may be adapted to n measurements. Further, a confidence assessment of the system status, i.e., a check of whether the system status is moving with a given probability within specified limits can be used for the last n measurements to determine error status. For example, the methodology for this confidence assessment may be found in the book Bronstein, Taschenbuch der Mathematik, 25th edition 1991, p. 684-686. It is also conceivable that additional error recognition procedures such as a hypothesis test might be used. For this, the significant criterion is that the error recognition be related to a specified interval of n measurements. This interval represents the time delay with which an error is recognized.

The invention is thus used to determine a probability value or index used to determine the error status.

To evaluate this error status (in contrast to conventional observer bank methods), two limit or threshold values are defined by means of which the error status of each observer, i.e., the main or sub-observer, is evaluated. The first threshold value is based on whether an error could arise in the applicable observer. A second threshold value determines whether this observer is evaluated to have an error. FIG. 1 shows error statuses that lie above the second threshold value (error-free observers) in which an error may also not arise over time (designated a). Observers whose error statuses lie between the first and second threshold values are designated b. Also, in FIG. 1, observers with an error status that lies below the second threshold value are designated c. An observer with such error status is considered to be erroneous.

Based on the invention procedure, the sensor fusion operates on the basis of the main observer as long as the error status lies within the a or b range. Also the observer bank always returns to this main observer if the main observer moves from another range into the a or b range. If the main observer lies within the a or b range, the system status is the same, i.e., the values calculated by it are transmitted. The threshold value may be considered to be a validity criterion of the applicable sensors or system models, or may also be interpreted as an accuracy limit that the system status may not exceed.

In the example shown in FIG. 1, the main observer error status achieves the value b during time interval k+1. The error status therefore lies between the first and second limits. The sensor fusion system based on the invention interprets this result as a possibility that an error might form within the main observer. The observer bank is activated at this point. This is achieved by the fact that all sub-observers are activated and are initialized with the main observer. This initialization is based on the overall system status, as well as on past n−1 residua that are significant for the determination of relevant future error statuses. At point k+1, however, an initialization has occurred. The output of the observer bank reflects the system status of the main observer, but not that of the sub-observers.

During a procedure based on the invention, activation of a sub-observer (and thereby deactivation of the main observer) occurs only when the main observer's error status falls below the second threshold. In FIG. 1, this occurs at time k+10, at which time the main observer possesses an error status c. In such a case, the sub-observer 12 which to this point in time has possessed the best error status, is activated. In the example shown in FIG. 1, this is the sub-observer that uses the LINS and TRN signals. This situation is considered to comprise a GPS sensor error. If no sub-observer has error status a or b, then the very unlikely situation would have occurred in which all GPS, LINS, and TRN sensors have failed, meaning that the entire observer bank was erroneous. Then a warning would be issued that the observer bank output is erroneous.

During the next time interval, the main observer is reinitialized by the LINS/TRN observer, i.e., the current system status and the past n−1 residua or probability indices of the main observer are overwritten based on the observers processing the LINS and TRN or the residua that the LINS/TRN received upon initialization. Since the main observer error status issued in this example has a value a, and it is thereby assumed that no error may occur in the main observer, the observer bank is deactivated. If the main observer had a statistical significance b, this would lead to re-initialization of the observer bank during time interval k+11. In such case, the other sub-observers would be initialized during time interval k+11 by the values of the LINS/TRN sub-observer. If the main observer had error status c, the best observer with error status a or b would be engaged after activation of the observer bank. It is also applicable during time interval k+10 that if no sub-observer has error status a or b, then the very unlikely situation has occurred that all GPS, LINS, and TRN sensors have failed, meaning that the entire observer bank was erroneous. Then a warning would be issued that the observer bank output is erroneous. The procedure based on the invention thus prevents discard of correct sensor signals or system models during sensor errors or system model errors that occur over time before and after the sensor error or system model error. Correct sensor signals or system models before the error are used, since operation before the error is based on the function of the main filter. Since the observer bank switches to the main observer as soon as the probability indices or residua of the last n time intervals produce an error status of a or b, correct sensor signals or system models are used after the error.

In a main observer considered to be erroneous whose last n−1 residua were overwritten with the residua of the sub-observer that features the best probability index, the determination of the error status is always based on a predetermined number n of the last observer residua considered to be correct.

The procedure based on the invention may be applied to any sensor system based on observers in that the sensors named in the example (LINS, GPS, and TRN) may be replaced by other sensors, combinations of sensors, and system models. Examples for such application fields are chemical process control, power station control, and vehicle and other aircraft systems. Also, actuator or motor failures, for example, could be recognized, and the system model could be suitably adapted.

1. Reconfiguration method for an error-tolerant system with at least one set of observers that are each formed from various combinations of sensors and a system model whereby the set of observers cause time-dependent operating statuses to fulfill system functions, whereby past deviations of the measured system status of this combination of one of the estimated system statuses of the assigned observers are used to determine the error status of each of these combinations of sensors for each time interval,
characterized in
the provision of a first and a second threshold value related to the error status, whereby the attainment of the first threshold value is an indicator for the occurrence of an error in that component, and attainment of the second threshold value results in the determination that the sensor or system model combination is erroneous, whereby, for determination of the error status of each of these combinations, a predetermined number n of past deviations from a measured system status of this combination is determined from the estimated system status of an assigned observer, and an error status is derived for that particular time interval,
thus based on an initial condition in which a first observer is active and at least one additional redundant sensor or system model combination in inactive condition is available, during attainment of the first threshold value in the first observer via the following steps:
1.1. engaging at least one additional observer with a different combination of sensors or of the system model,
1.2. input of deviations of the last n−1 time intervals from the observer that reported the error into said at least one additional observer,
1.3. input of the current system status from the observer that reported the error into said at least one additional observer,
1.4. determination of the error status in the first observer based on the last n deviations measured by it,
1.5. determination of the error status in said at least one additional observer based on the last n deviations that said at least one additional observer itself reported, or that it received upon activation,
1.6. deactivation of said at least one additional observer as soon as the first observer falls below the first threshold value,
and by attainment of the second threshold value by means of the following steps:
1.7. deactivation of each first observer for the course of this time interval
1.8. activation of the observer with the most favorable error status of said at least one additional observer used to verify the system functions,
1.9. input of deviation of the last n−1 time intervals from the observer with the most favorable error status into the first observer based on the last n−1 deviations that the most favorable observer itself has reported, or that it received upon activation
1.10. input of the current system status from the most favorable observer into the first observer,
1.11. determination of error status in the first observer based on the last n deviations that the first observer itself reported, or that it received upon activation,
1.12. repetition of steps 1.1 to 1.6, as soon as the first threshold value is reached
1.13. repetition of steps 1.7 to 1.11, as soon as the second threshold value is reached.

2. Reconfiguration method for an error-tolerant system with at least one set of observers as in claim 1, characterized in that the determination of the error status results from a confidence assessment.

3. Reconfiguration method for an error-tolerant system with at least one set of observers as in claim 1, characterized in that determination of the error status results from the formation of a statistical significance.
